(19) United States
(12) Patent Application Publication
(10) Pub. No.: US 2015/0358533 A1
(43) Pub. Date: Dec. 10, 2015

(54) CONTROL METHOD FOR IMAGING APPARATUS AND IMAGING SYSTEM

(71) Applicant: CANON KABUSHIKI KAISHA, Tokyo (JP)

(72) Inventor: Katsuyuki Tanaka, Tokorozawa-shi (JP)

(21) Appl. No.: 14/725,074

(22) Filed: May 29, 2015

(30) Foreign Application Priority Data
Jun. 5, 2014 (JP) 2014-116638

(51) Int. Cl. H04N 5/232; G02B 21/36

(52) U.S. Cl. CPC H04N 5/23222; G02B 21/361

(57) ABSTRACT

In a first disposing step, a plurality of imaging elements are disposed in positions which are different in an optical axis direction. Then an object is imaged using the plurality of imaging elements while moving the object in a direction perpendicular to the optical axis using a movable stage, so as to acquire a plurality of image data of which focal positions with respect to the object in the optical axis direction are different (pre-imaging). An in-focus position with respect to the object is determined based on the plurality of image data acquired in the pre-imaging.

### BACKGROUND OF THE INVENTION

1. Field of the Invention

The present invention relates to control of an imaging apparatus that images an object using a plurality of imaging elements.

2. Description of the Related Art

In the field of pathology, a virtual slide system which images a specimen mounted on a slide (also called a “preparation”), acquires digital images thereof, and performs pathological diagnosis on the display using viewer software is gaining attention.

In order to perform quick and accurate pathological diagnosis using a virtual slide system, the entire image of the specimen on the slide must be captured at high-speed and high resolution. To implement such a system, a digital microscope apparatus has been proposed, in which an objective lens having a wide field of view and high resolution is used and an imaging element group is disposed in the field of view of the lens so as to image a specimen at high-speed and high resolution (Japanese Patent Application Laid-Open No. 2009-003016).

The depth of field of an object lens that is used for a microscope is extremely shallow, and the range thereof is relatively very narrow with respect to the thickness of a specimen which is normally prepared. Therefore in order to acquire an in-focus image, the focal position must be set in a range where tissues or cells exist in the specimen to be observed.

Furthermore, the surface of the specimen is not perfectly flat and has unevenness (waviness). Tissues and cells in the specimen tend to distribute along this waviness, and in some cases an appropriate focal position to acquire an in-focus image may be different depending on the position on the slide (horizontal position).

As a method for observing layers having different depths in the specimen at high-speed, Japanese Patent Application Laid-Open No. 2004-151263 proposes a method for generating images of a plurality of layers at the same time, using an optical lens that forms images of areas having different depths in the specimen respectively all at once, and using a plurality of line sensors disposed for each layer.

Moreover, as an autofocus (AF) technique of a digital camera, Japanese Patent Application Laid-Open No. 2001-215406 proposes to increase the speed of the direction determination processing in the AF operation by utilizing the structural characteristics (step differences) of the imaging elements. In this configuration, a plurality of image signals is collected with changing the optical path length by a micro-distance, the in-focus direction is determined based on the collected image signals, and the imaging lens is moved in the determined in-focus direction until reaching the in-focus position.

### SUMMARY OF THE INVENTION

Critical to directly influencing the speed of a specimen observation is whether the in-focus image of the specimen can be accurately acquired. If the acquired image is blurred, imaging must be executed again after adjusting the in-focus position, which wastes time.

To accurately acquire a in-focus image, the surface profile of the specimen and the range where the observation object exists in the specimen (depth direction, optical axis direction) are searched prior to actual imaging, and each imaging element is disposed so that the focal point is set to the z position (in-focus position) of the specimen, which is calculated based on the search result (hereafter the position of an imaging element by which an in-focus image can be acquired is called “imaging element optimum position”).

A conventionally available method for searching the surface profile and the range where the observation target exists is a method to recognize this information based on the position information measured by a laser displacement meter or the like. A problem with this method, however, is that the result greatly depends on the precision of the measurement apparatus, such as the laser displacement meter. If a measurement apparatus having low performance is used to control cost, or if an assembly accuracy of the measurement apparatus is poor, error is generated between the image plane calculated from the measurement result and the image plane generated by the image forming optical system used for the actual imaging, and as a result blur is generated in the image. Installing a high precision measurement apparatus or improving assembly accuracy, on the other hand, makes the size of the imaging apparatus larger and increases cost, which is impractical.

In Japanese Patent Application Laid-Open No. 2001-215406, a plurality of image signals is collected with changing the optical path length by a micro-distance, utilizing the structural characteristics (step differences) of the imaging elements, and based on the collected image signals, the in-focus direction is determined and the lens is moved. If this method is used, such a measurement apparatus as the laser displacement meter is unnecessary. However, in the case of Japanese Patent Application Laid-Open No. 2001-215406, the imaging elements for which the plurality of image signals is collected are different from the imaging elements that are used for the actual imaging after the lens is adjusted, therefore defocus is generated due to the difference in the imaging elements, and high precision cannot be implemented.

It is preferable that the time required for pre-processing, such as the search of an in-focus position, is as short as possible. Because if a wait time is generated until the start of the actual imaging and the display of the diagnostic image, quick pathological diagnosis becomes difficult. Further, if the pre-processing takes too much time when digitizing many slides in batch, throughput of the apparatus as a whole drops, and the number of processed images per unit time decreases.

With the foregoing in view, it is an object of the present invention to provide a technique to efficiently search an in-focus position of the object.

A first aspect of the present invention resides in a control method for an imaging apparatus that has an image forming optical system, a plurality of imaging elements and a movable stage for holding an object, the method comprising: a first disposing step of disposing the plurality of imaging elements in positions which are different in an optical axis direction; a first imaging step of imaging the object using the plurality of imaging elements disposed in the first disposing step, while moving the object in a direction perpendicular to the optical axis using the movable stage, so as to acquire a plurality of image data of which focal positions with respect to the object in the optical axis direction are different; an in-focus position determination step of determining an in-focus position with respect to the object, based on the plurality of image data acquired in the first imaging step; a second disposing step of changing disposition of the plurality of imaging elements, based on the in-focus position determined in the in-focus position determination step; and a second imaging step of imaging the object using the plurality of imaging elements disposed in the second disposing step.

A second aspect of the present invention resides in an imaging system comprising: an image forming optical system; a plurality of imaging elements; a movable stage for holding an object; and a control processing unit, wherein the control processing unit executes a control that includes: a first disposing step of disposing the plurality of imaging elements in positions which are different in an optical axis direction; a first imaging step of imaging the object using the plurality of imaging elements disposed in the first disposing step, while moving the object in a direction perpendicular to the optical axis using the movable stage, so as to acquire a plurality of image data of which focal positions with respect to the object in the optical axis direction are different; an in-focus position determination step of determining an in-focus position with respect to the object, based on the plurality of image data acquired in the first imaging step; a second disposing step of changing disposition of the plurality of imaging elements, based on the in-focus position determined in the in-focus position determination step; and a second imaging step of imaging the object using the plurality of imaging elements disposed in the second disposing step.

A third aspect of the present invention resides in a non-transitory computer readable storage medium that stores a program for executing each step of the control method for an imaging apparatus according to the present invention, by a control processing unit of the imaging apparatus.

According to the present invention, the in-focus position of the object can be searched efficiently.

Further features of the present invention will become apparent from the following description of exemplary embodiments with reference to the attached drawings.

### BRIEF DESCRIPTION OF THE DRAWINGS

FIG. 1 is a schematic diagram depicting a flow of the control of the imaging system according to an embodiment of the present invention;

FIG. 2 is a diagram depicting a configuration of the imaging system;

FIG. 3 is a block diagram depicting a hardware configuration to implement the functions of the system control unit;

FIGS. 4A and 4B are diagrams depicting a specimen and a slide;

FIGS. 5A and 5B are diagrams depicting a configuration of the apparatus and images of pre-imaging according to Embodiment 1;

FIG. 6 is a diagram depicting a specimen surface profile acquisition unit;

FIGS. 7A and 7B are schematic diagrams depicting a concept of the pre-imaging by the imaging apparatus according to Embodiment 1;

FIG. 8 is a schematic diagram depicting a pre-imaging area imaged by the imaging apparatus according to Embodiment 1;

FIG. 9 is a flow chart depicting an operation of the imaging system;

FIGS. 10A and 10B are diagrams depicting the configuration of the apparatus according to Embodiment 2;

FIGS. 11A and 11B are schematic diagrams depicting a concept of the pre-imaging by the imaging apparatus according to Embodiment 2;

FIG. 12 is a schematic diagram depicting a pre-imaging area imaged by the imaging apparatus according to Embodiment 2;

FIG. 13 is a flow chart depicting details of step S904 in FIG. 9; and

FIG. 14 is a flow chart depicting details of step S905 in FIG. 9.

### DESCRIPTION OF THE EMBODIMENTS

The invention relates to an imaging system that images an object (e.g. slide) at high-speed and high resolution using an imaging apparatus including an image forming optical system and a plurality of imaging elements, so as to acquire a high resolution digital image. This system is also called a “digital microscope system” or a “virtual slide system”, and application to image inspections, including pathological diagnosis, is expected.

As mentioned above, in this type of imaging system, the thickness of the observation target (cells and tissues) inside the object varies depending on the sample, although the depth of field of the objective lens is very small compared with the thickness of the object. Therefore in the present invention, pre-imaging of the object is executed before actual imaging using the same imaging system as the actual imaging, the optimum in-focus position is determined using an image acquired by the pre-imaging, and the actual imaging is executed after the position and the orientation of each imaging element are controlled based on this in-focus position.

<Outline of Control Method for Imaging Apparatus>

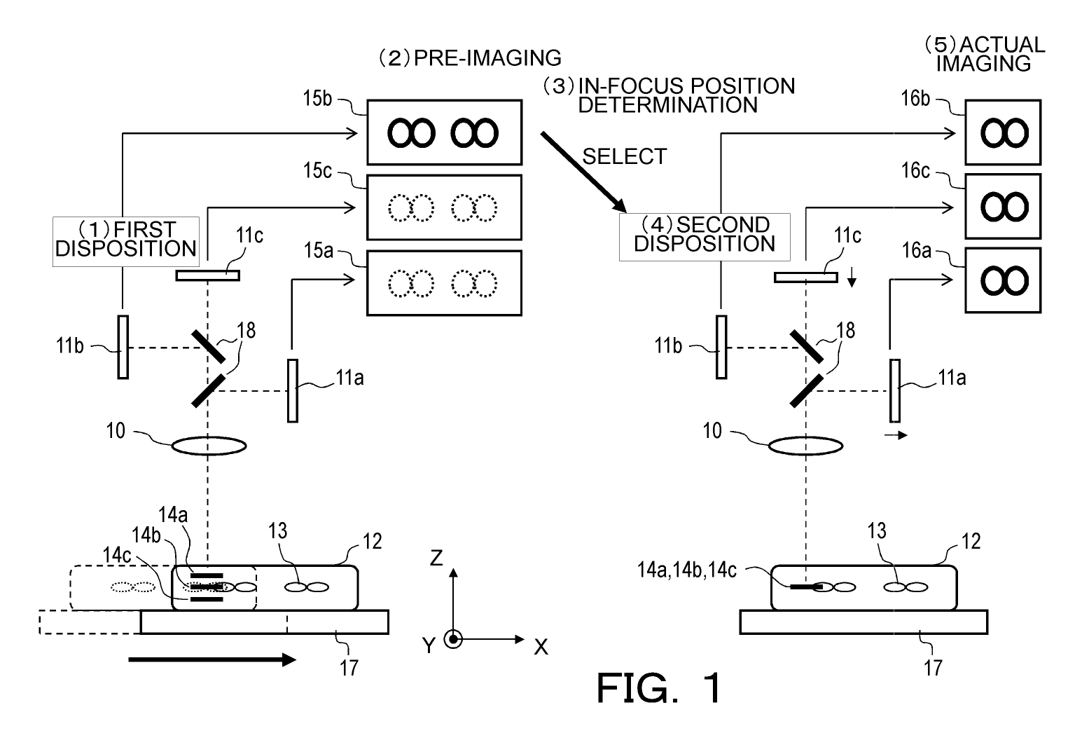

FIG. 1 is a schematic diagram depicting a general flow of the pre-imaging and the actual imaging. In FIG. 1, 10 denotes an image forming optical system, 18 denotes a split optical system that splits an optical path, 11a to 11c denote imaging elements, 12 denotes an object, and 13 denotes an observation target in the object. Here it is assumed that the observation target (object to be imaged) 13 exists at around an intermediate depth of the object 12. 14a to 14c denote focal points (focal planes) on the object side corresponding to the imaging elements 11a to 11c. The focal planes 14a to 14c are parallel with each other, and are in optically conjugate positions with the light receiving surfaces of the imaging elements 11a to 11c with respect to the optical system (image forming optical system and split optical system). 15a to 15c are image data acquired from the imaging elements 11a to 11c in the pre-imaging. 16a to 16c are image data acquired from the imaging elements 11a to 11c in the actual imaging. 17 denotes a movable stage that holds the object 12. In FIG. 1, the z axis is parallel with the optical axis of the image forming optical system 10, and the object 12 is disposed parallel with the xy plane. The movable stage can move in the x direction, the y direction and the z direction respectively.

(1) First Disposing Step

In the initial stage, the in-focus position with respect to the object 12 (a position in a thickness direction of the object 12 to which a focal point of each of imaging elements 11a to 11c is set) is unknown. Hence the disposition of each of the imaging elements 11a to 11c (position, orientation or the like in the optical axis direction) is adjusted so that the z positions of the focal points 14a to 14c are different from one another. In the example in FIG. 1, the dispositions of the imaging elements 11a, 11b and 11c are set so that the depth increases (the position is more distant from the surface of the object 12) in steps in the sequence of the focal points 14a, 14b and 14c.

(2) Pre-Imaging Step (First Imaging Step)

The object 12 is imaged using a plurality of imaging elements 11a to 11c disposed in the first disposing step. By imaging the object while moving the movable stage 17 in the x direction at this time, image data on the entire area (or required range) of the object 12 in the x direction is acquired. The entire area in the x direction may be scanned by sequentially loading images while moving the movable stage 17 continuously (at a predetermined speed), or a step movement of the movable stage 17 (change of the imaging area) and execution of imaging may be repeated alternately.

As a result, a plurality of image data 15a to 15c, of which focal positions with respect to the object 12 are different, is acquired from each of the imaging elements 11a to 11c. The focal position is deeper in the sequence of image data 15a, 15b and 15c. In the example in FIG. 1, the position where the object 13 exists and the position of the focal point 14b match. Therefore the image data 15b generates an image focused on the object 13, but the image data 15a and 15c generate images where the object 13 is blurred.

(3) Focusing Position Determination Step

Then the depth of the focal point where the in-focus image is acquired (in-focus position) is determined by comparing the image data acquired in the pre-imaging step. For example, an imaging element from which the most in-focus image is acquired is specified by comparing the contrast values and the edge components in the image data 15a to 15c, and a focal position that is set for this imaging element is selected as the in-focus position. In the example in FIG. 1, the image data 15b acquired by the imaging element 11b is the most focused, therefore the position of the focal point 14b is selected as the in-focus position.

(4) Second Disposing Step

Then based on the in-focus positions determined in the in-focus position determination step, the imaging elements 11a to 11c are disposed again. In this case, the positions (depths) of the focal points 14a to 14c of all the imaging elements 11a to 11c may match as shown in FIG. 1, or the positions (depths) of the focal points 14a to 14c of the respective imaging elements 11a to 11c may be different. The optimum dispositions of the focal points 14a to 14c change depending on the configuration of the imaging apparatus, the purpose of imaging or the like. For example, if the imaging elements 11a to 11c are configured to execute imaging using different color channels (e.g. R, G and B) and to acquire a color image by one shot, the former disposition is preferable where the focal positions match. In the case when the imaging elements 11a to 11c are configured to have different imaging areas (xy positions) from one another and to image a wide range by one shot as well, the former disposition is preferable where the focal positions match. The latter disposition is suitable for processing to acquire a plurality of image data (stack images) of which focal positions are slightly shifted in sequence from the z range near the in-focus position, for example.

For simplification, a same in-focus position may be used as a reference for the entire area of the object 12. If waviness and unevenness on the surface of the object 12 cannot be ignored, however, the position and orientation (inclination) of each of the imaging elements 11a to 11c may be adjusted in accordance with the surface profile. For example, it is preferable to specify a range of each of focal points 14a to 14c based on the surface profile (surface height) of the object 12. In other words, the distance in the optical axis direction between the actual surface of the object 12 and the focal point is regarded as “the range of the focal point”. If the surface of the object 12 is wavy, the object 13 tends to exist according to this wavy profile. Therefore if the range of the focal point is considered based on the surface profile, focusing on the in-focus positions becomes possible in the entire area of the object 12.

(5) Actual Imaging Step (Second Imaging Step)

The actual imaging of the object 12 is executed by the plurality of imaging elements 11a to 11c which were disposed again in the second disposing step. Thereby as shown in FIG. 1, in-focus image data 16a to 16c can be acquired by all the imaging elements 11a to 11c.

According to the method described above, the imaging system used for the actual imaging is also used for detecting the in-focus position, hence additional equipment to detect the in-focus position is unnecessary, the system configuration can be simplified and downsized, and cost can be reduced. Further, the pre-imaging and the actual imaging can be performed continuously using the same imaging system, hence focal point deviation due to differences among the imaging elements is not generated, and focal points can be positioned at higher precision. Furthermore, the image data 15a to 15c used for the in-focus position determination can be acquired at high-speed by performing pre-imaging while moving the object 12, therefore time until the start of actual imaging (time for pre-processing) can be decreased.

If the movable stage 17 also serves as transport means for loading the object 12 from another apparatus (e.g. stocker to house slides or another measurement system), it is preferable to perform pre-imaging while the object 12 is moving to be loaded from another apparatus to the imaging position of the actual imaging. By performing pre-imaging utilizing the load operation and the loading time of the object 12, the time of the pre-imaging can be virtually shorter, and the pre-processing time can be further decreased.

Concrete configuration examples to implement the above mentioned control method for the imaging apparatus will now be described in detail.

### Embodiment 1

In this embodiment, it is defined that the z axis is in the optical axis direction, and the x axis and the y axis are perpendicular to the z axis. If the coordinate axes are specified in the description of each drawing, the coordinate axes described in each drawing take precedence over this definition.

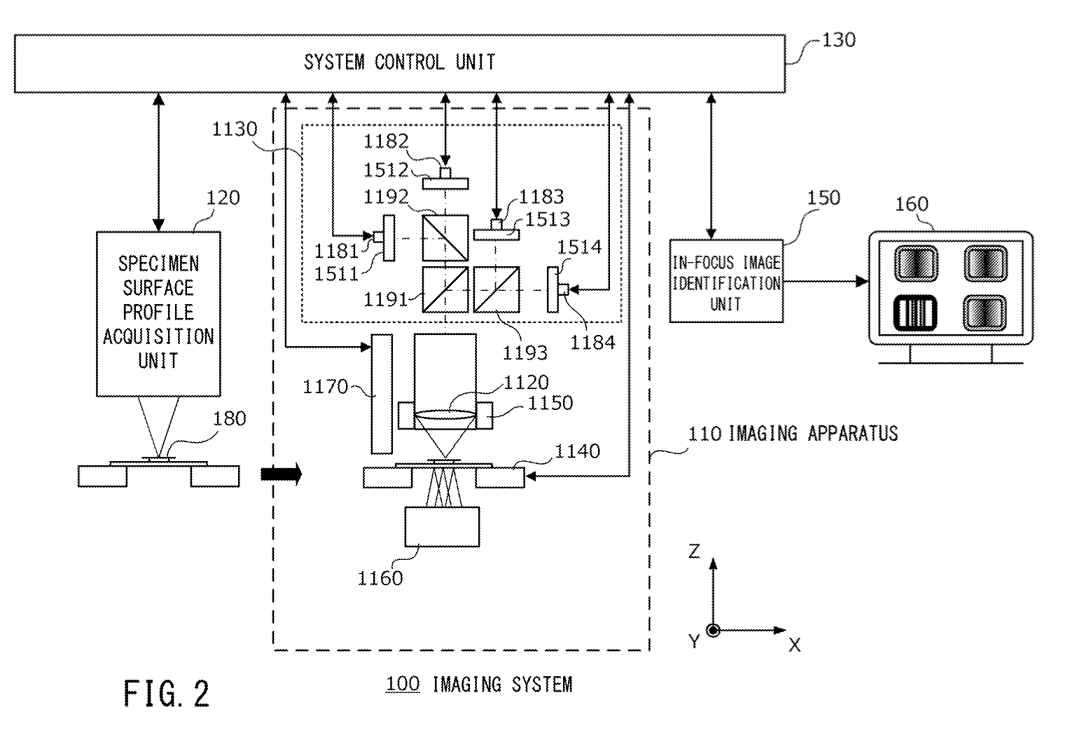

FIG. 2 is a general view of an imaging system according to Embodiment 1 of the present invention. The imaging system 100 is constituted by four sub-systems: an imaging apparatus 110 that images a specimen 180; a specimen surface profile acquisition unit 120 that acquires surface profile information of the specimen 180, an in-focus image identification unit 150 that generates a two-dimensional image and identifies an in-focus image; and a monitor 160 that is a display unit. Each sub-system is integrally controlled by the system control unit 130. In this embodiment, the system control unit 130 and the in-focus image identification unit 150 constitute a control processing unit that performs various controls and arithmetic processing in the imaging apparatus 110.

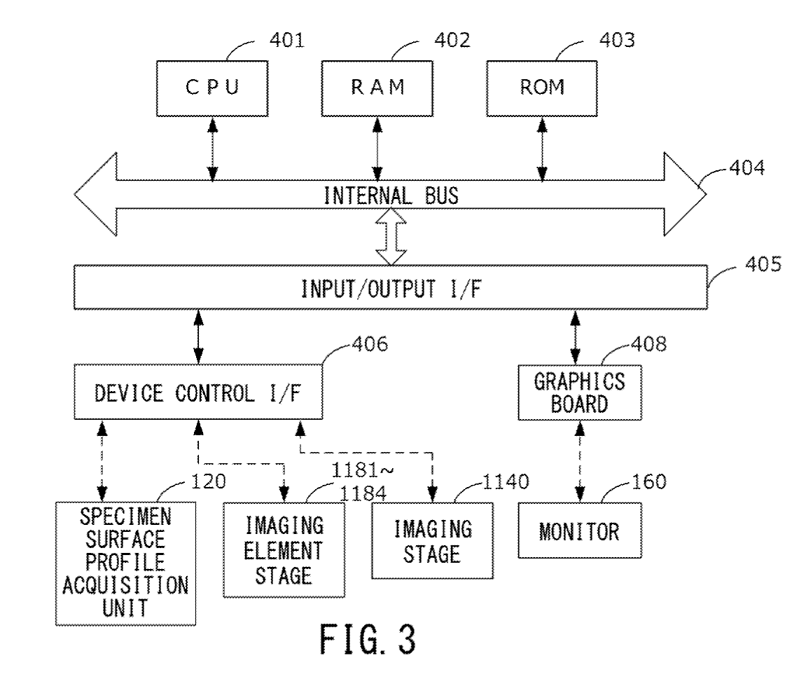

The configuration of the imaging system, however, is not limited to the configuration in FIG. 3. For example, the specimen surface profile acquisition unit 120 may be integrated with the imaging apparatus 110, or the monitor 160 may be integrated with the in-focus image identification unit 150. The functions of the in-focus image identification unit 150 (e.g. image processing function, in-focus image identification function) may be integrated into the imaging apparatus 110. The functions of each sub-system may be shared with and implemented by a plurality of apparatuses.

FIG. 3 is a block diagram depicting a hardware configuration to implement the functions of the system control unit 130. The system control unit 130 integrally controls each component of the imaging system 100. For example, the system control unit 130 controls to measure the profile of the specimen, to move the imaging stage 1140, to select the coordinate origin in the z axis direction, to measure the distance to the upper surface of the specimen, to drive the imaging unit 1130, to instruct execution of imaging to the imaging elements 1511 to 1514, and to send image data to the in-focus image identification unit 150. The system control unit 130 may be a personal computer (PC) or a programmable logic controller (PLC) as an apparatus to perform system control. The following description is based on the assumption that a PC is used.

The PC includes a central processing unit (CPU) 401, random access memory (RAM) 402, a storage device 403, a data input/output I/F 405, and an internal bus 404 that inter-connects these components.

The CPU 401 accesses RAM 402 or the like when necessary, and integrally controls each functional block of the PC while executing various types of arithmetic processing required for control.

The RAM 402 is used as a work area of the CPU 401, and temporarily stores the OS, various programs during execution, and various data on the imaging stage 1140 and the imaging element stages 1181 to 1184 that are moved for searching the in-focus positions, which are the characteristics of the present invention.

The ROM 403 is an auxiliary storage device that records and reads the OS that the CPU 401 executes, and information fixed in firmware, such as programs and various parameters. For the ROM 403, such magnetic disk drives as a hard disk drive (HDD) and a solid-state disk (SSD) or a semiconductor device using flash memory is used.

The data input/output I/F 405 is connected to the specimen surface profile acquisition unit 120, the imaging element stages 1181 to 1184, and the imaging stage 1140 via the device control I/F 406. The data input/output I/F 405 is also connected to the monitor 160 via a graphics board 408. Here the monitor 160 is assumed to be connected to an external device, but a PC integrated with a display device may be used.

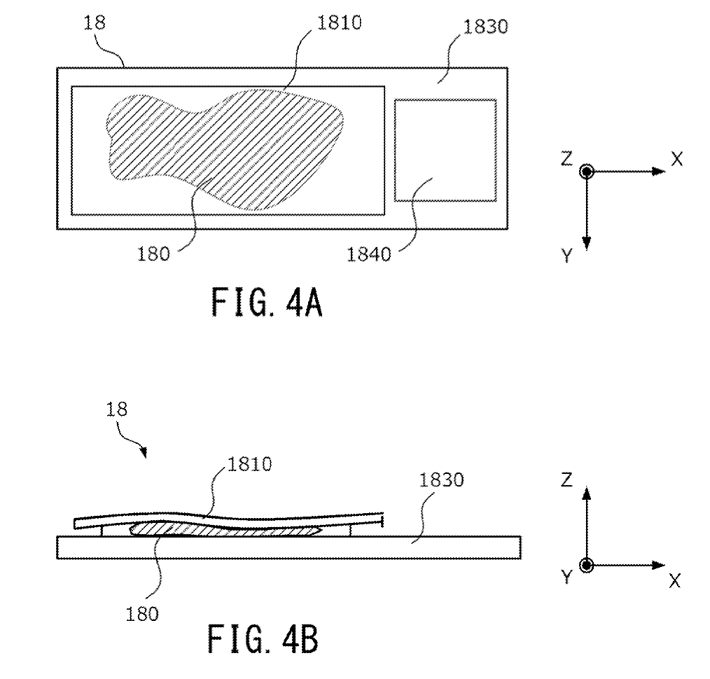

FIG. 4A and FIG. 4B are diagrams depicting the configuration of a slide (also called a “preparation”) 18, which is an example of the object. FIG. 4A is a plan view of the slide 18, and FIG. 4B is a slide view of the slide 18. Here the optical axis direction is defined as the z axis, and axes perpendicular to the z axis are defined as the x axis (longer direction of the slide) and the y axis (shorter direction of the slide). The slide 18 is constituted by a slide glass 1830, a cover glass 1810, a specimen 180 and a label 1840. The specimen 180 is sealed between the slide glass 1830 and the cover glass 1810 using sealing material. As illustrated in FIG. 4B, it is rare that the surface of the slide 18 is perfectly flat, and waviness due to the unevenness of the slide glass 1830, the cover glass 1810 or the specimen 180 often exists. The label 1840 is a member on which management information, to manage the specimen 180, is recorded. The management information may be printed or written by pen on the label 1840, or may be recorded as a one-dimensional barcode or two-dimensional barcode, or may be electrically, magnetically or optically recorded in a recording medium attached to the label 1840. An RF-ID tag, for example, may be used.

Each element constituting the imaging system 100 will be described.

As illustrated in FIG. 2, the imaging apparatus 110 includes an illumination unit 1160, an imaging stage 1140, an image forming optical unit 1120, an imaging stage position/orientation measurement unit 1150, an imaging unit 1130, and a specimen upper surface measurement unit 1170. Here it is assumed that the z axis is parallel with the optical axis of the image forming optical unit 1120 of the imaging apparatus 110, and the x axis and the y axis are perpendicular to the optical axis and are parallel with the surface of the object.

The illumination unit 1160 is a unit to illuminate the specimen 180 on the imaging stage 1140, and includes a light source and an optical system that guides the light from the light source to the specimen 180. For the light source, a white light source or a light source that can switch light having an R, G and B wavelength, for example, can be used.

The imaging stage position/orientation measurement unit 1150 is a unit that measures the position and orientation of the imaging stage 1140 with respect to the image forming optical unit 1120 (the object surface thereof). The imaging stage position/orientation measurement unit 1150 includes three distance sensors, which are disposed around the lens barrel of the image forming optical unit 1120 (at the same height). The imaging stage position/orientation measurement unit 1150 measures the distance to the upper surface of the imaging stage 1140 using each distance sensor, and calculates the inclination and the xy position of the imaging stage 1140 with respect to the image forming optical unit 1120 based on the acquired three distances. The number of sensors (number of distance measurement points) may be more than three. For the measurement by the imaging stage position/orientation measurement unit 1150, various distance measurement sensors, laser displacement meters, capacitance type displacement meters or the like can be used.

The imaging stage 1140 is a movable stage that holds (supports) the slide 18, and can translationally move in the x, y and z directions, and can tilt around the x axis and the y axis by a moving mechanism (not illustrated). The imaging stage 1140 can also reciprocate between the imaging apparatus 110 and the specimen surface profile acquisition unit 120, and also serves as transport means for loading the slide 18 from the specimen surface profile acquisition unit 120 to the imaging position in the imaging apparatus 110. Thereby the surface profile measurement processing by the specimen surface profile acquisition unit 120 and the imaging processing by the imaging apparatus 110 can be executed continuously for the specimen 180 on the imaging stage 1140. The moving mechanism of the imaging stage 1140 controls so that the position and orientation of the imaging stage 1140 becomes the desired values using the measurement results of the imaging stage position/orientation measurement unit 1150. For example, the position and orientation of the imaging stage 1140 are controlled so that the imaging plane of the imaging element, which become a reference among a plurality of imaging elements, becomes parallel with the lower surface of the slide 18 or with a certain layer surface in the z direction in the range where the specimen exists.

Various mechanisms can be used for the moving mechanism of the imaging stage 1140. For example, the movement in the x and y directions can be implemented by the translation mechanism using a ball screw, and the z translation and the xy tilting can be implemented by a vertical mechanism using three or more piezoelectric elements. The imaging stage 1140 may also serve as means for loading a slide from a stocker housing slides, although this is not illustrated.

The image forming optical unit 1120 is a unit including an image forming optical system that expands the optical image of the specimen 180 at a predetermined magnification, and forms the image on the imaging surface of the imaging unit 1130.

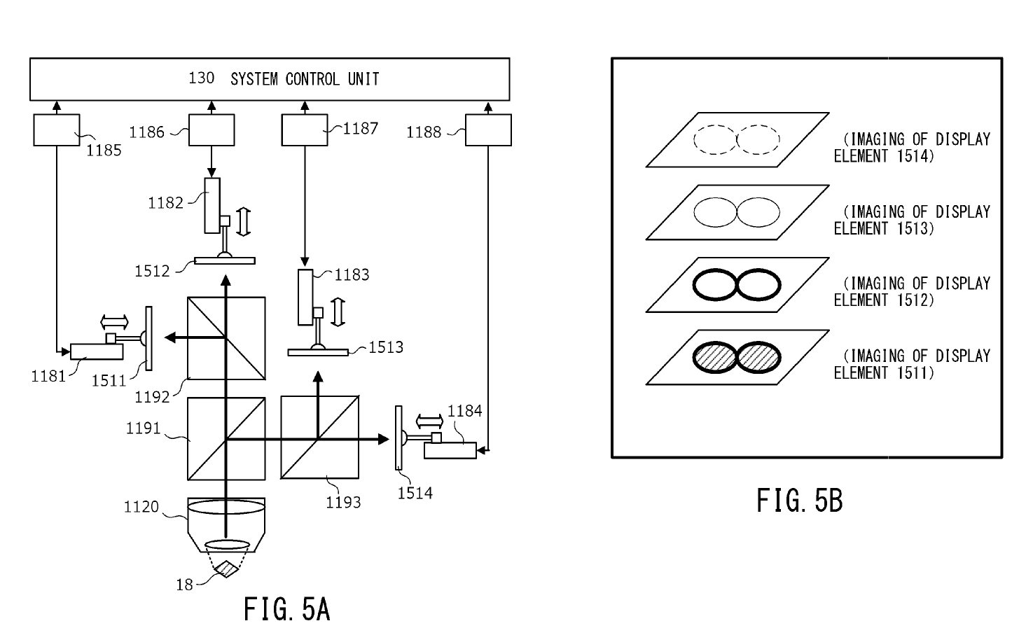

FIG. 5A and FIG. 5B show the configuration of the imaging unit 1130. FIG. 5A is a diagram depicting the configuration and positional change of the imaging elements 1511 to 1514, the imaging element stages 1181 to 1184, the optical path split prisms 1191 to 1193; FIG. 5B is an example of an image acquired by each imaging element.

The imaging elements 1511 to 1514 are two-dimensional imaging elements, such as charge-coupled device (CCD) or complementary metal oxide semiconductor (CMOS) image sensors, and are held by a main unit frame (not illustrated). The four light receiving surfaces of the imaging elements 1511 to 1514 are disposed such that four focal planes on the object side, which are optically conjugate with the light receiving planes via the optical system (image forming optical unit 1120 and optical path split prisms 1191 to 1193), are parallel with one another. Each of imaging elements 1511 to 1514 images the object according to the control instructions from the system control unit 130, and generates the imaging data thereof. In this embodiment, the two-dimensional imaging elements (area sensors) are used, but one-dimensional imaging elements (line sensors) may be used instead.

As a driving mechanism to linearly move the light receiving surface in a direction parallel with the optical axis, the imaging elements 1511 to 1514 include the imaging element stages 1181 to 1184 and the motor drivers 1185 to 1188 respectively. The motor drivers 1185 to 1188 can drive the imaging element stages 1181 to 1184 respectively according to the control target values output from the system control unit 130, so as to independently change the position in the optical axis direction (z position) and the orientation of the imaging elements 1511 to 1514. The imaging element stages 1181 to 1184 can drive the imaging elements at a positioning accuracy that is about a square of the optical magnification of the image forming optical unit 1120. The driving mechanism for the imaging element may be constituted by a linear motion system that drives utilizing a linear motor, a DC motor using a linear motion ball screw, a pulse motor, VCM or the like, or by a mechanism including a guide mechanism utilizing elasticity and deformation of a member, such as a plate spring and a piezo-actuator.

The specimen upper surface measurement unit 1170 is measurement means for measuring the height of the surface of the specimen 180 (z position in the optical axis direction) held by the imaging stage 1140. The specimen upper surface measurement unit 1170 acquires the height information (z position information) on at least one point (one xy coordinate) on the surface of the specimen 180. For the measurement, a distance sensor, such as a laser displacement meter, can be used, for example. The laser displacement meter measures the z position on the upper surface of the cover glass 1810, but this information may be directly output as the height information on the upper surface of the specimen. If the thickness of the cover glass is known, the z position of the lower surface of the cover glass 1810 (boundary between the cover glass 1810 and the specimen 180) may be calculated from the measurement result, and this information may be output. The coordinate origin in the z direction, which is the reference of the height, can be, for example, a position of the imaging stage 1140 (the lower surface position of the slide 18) measured by the imaging stage position/orientation measurement unit 1150.

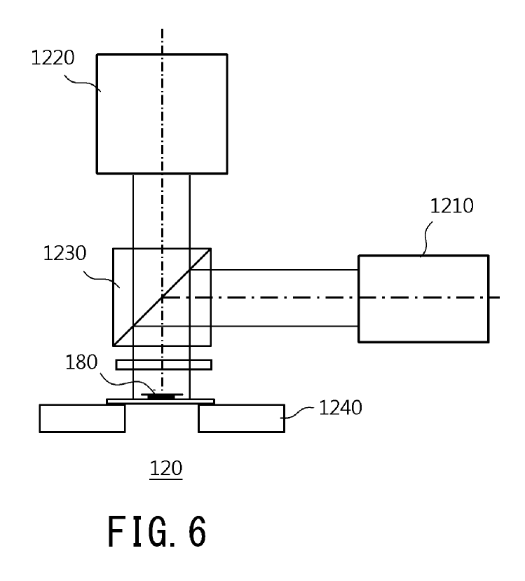

FIG. 6 shows a configuration of the specimen surface profile acquisition unit 120 (surface profile acquisition means). The specimen surface profile acquisition unit 120 includes a measurement illumination unit 1210 that illuminates the specimen 180 and a surface measurement unit 1220 that measures the profile of the surface of the specimen 180. The specimen surface profile acquisition unit 120 also includes a polarization beam splitter 1230 that reflects the light from the measurement illumination unit 1210 to the specimen 180 and transmits the light from the specimen 180 to the surface measurement unit 1220, and a λ/4 plate 1240. The measurement illumination unit 1210 uses a semiconductor laser, a white LED light source or the like as the light source, and irradiates the parallel light. The surface measurement unit 1220 includes a sensor to measure the wave surface, and calculates the profile of the wave surface of the light reflected by the surface of the specimen 180. The height of the surface of the specimen 180 is calculated based on the optical path length of the light and the height of the wave surface of the light. A Shack-Hartmann sensor or an interferometer is used for the sensor to measure the wave surface.

The height of a plurality of measurement points (xy coordinates) of the specimen 180 may be measured by position measurement instruments, such as a laser displacement meter and a contact type position sensor, so that the surface profile is calculated by interpolating the heights of these measurement points. As a method for interpolating the measurement points, a known method selected from a wide range of methods can be used, such as linear interpolation and high order (e.g. third order) interpolation. Further, the specimen surface profile acquisition unit 120 may acquire surface profile information prepared in advance, instead of measuring the surface profile. For example, if the surface profile information is recorded in the label 1840 of the slide 18, the specimen surface profile acquisition unit 120 may be an apparatus that reads information from the label 1840 (e.g. barcode reader, two-dimensional barcode reader, RF-ID reader). Further, the specimen surface profile acquisition unit 120 may be a communication apparatus that receives the surface profile information from an external data base or server via a network.

The in-focus image identification unit 150 has a function to determine the in-focus two-dimensional image data from a plurality of two-dimensional image data after generating two-dimensional image data from the imaging data acquired by the individual imaging element 1131, and to specify an imaging element 1131 that imaged the in-focus image. Focusing of the two-dimensional image data can be determined from the feature values, such as a contrast value of the image and the edge components. The in-focus image identification unit 150 may be constituted by a computer and an image processing program, or may be an image processing circuit board.

The monitor 160 displays a plurality of two-dimensional image data calculated by the in-focus image identification unit 150. The monitor 160 is constituted by a display device, such as a CRT and a liquid crystal display. The computed result by the in-focus image identification unit 150 is displayed because the user confirms whether the computed result is correct or not. Hence when many slides 18 are automatically processed in batch, the computed result by the in-focus image identification unit 150 may simply be written in a log, omitting displaying the result (confirmed by the user) on the monitor 160.

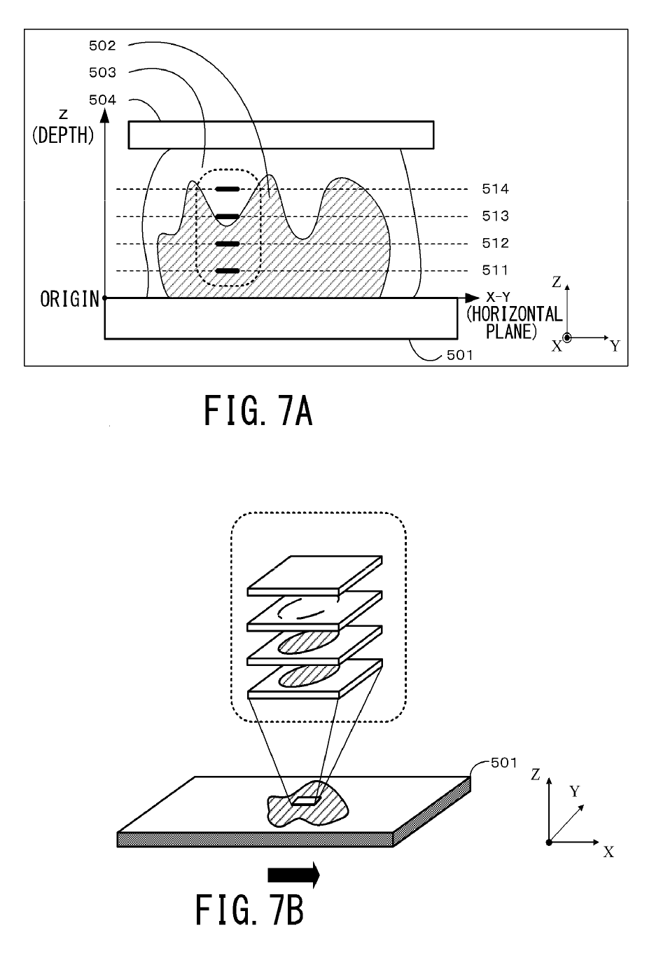

FIG. 7A is a cross-sectional view depicting the focal positions of the imaging elements 1511 to 1514 in the in-focus position search processing of Embodiment 1. 501 denotes a slide glass, 502 denotes a specimen, 503 denotes sealing material, and 504 denotes a cover glass. 511 to 514 denote the focal positions (focal planes) in the z direction corresponding to the imaging elements 1511 to 1514 respectively. The traveling direction of the imaging stage 1140 in the pre-imaging is the x direction, and FIG. 7A shows the disposition of the focal positions 511 to 514 when viewed from the plane perpendicular to the slide traveling direction, that is, the plane sectioned in the shorter side direction of the slide.

In the apparatus configuration of Embodiment 1, the imaging areas (positions on the xy coordinate plane) of the four imaging elements 1151 to 1154 are the same, but in the first disposing step, the four imaging elements 1151 to 1154 are disposed such that the focal positions 511 to 514 are at mutually different z positions (depths). FIG. 7B is a schematic diagram depicting an image formed on the light receiving surface of each of the imaging elements 1151 to 1154 in the disposition of the imaging elements in FIG. 7A. A clear (unblurred) image is acquired from the imaging elements 1151 and 1152 of which focal positions 511 and 512 are located in the object. A slightly blurred image is acquired from the imaging element 1153 of which focal position 513 slightly deviates from the specimen 502. A very blurred image is acquired from the imaging element 1154 of which focal position 514 greatly deviates from the specimen 502.

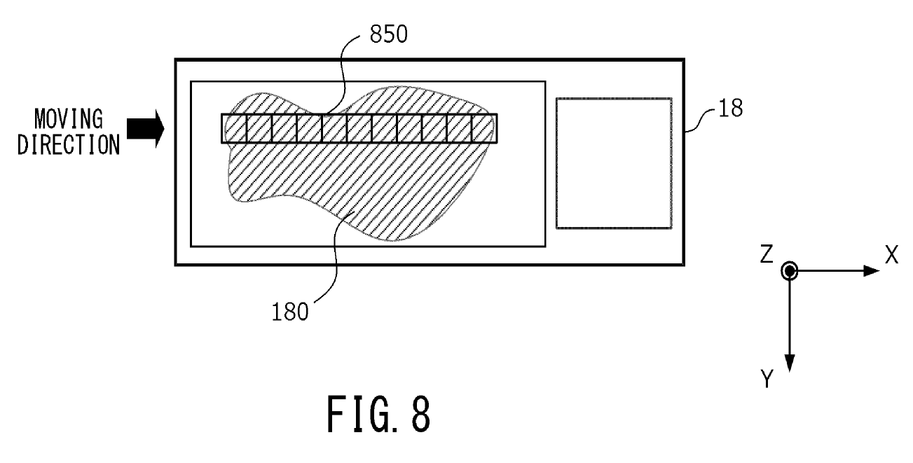

FIG. 8 is a schematic diagram depicting the pre-imaging area in the pre-imaging step of Embodiment 1, when viewed from the z direction. The pre-imaging area 850 is a belt-shaped area along the moving direction of the slide 18 (x direction). Each rectangular frame in the pre-imaging area 850 indicates the size of the imaging area (size of the field of view of the imaging system) of the imaging elements 1151 to 1154. In the example of FIG. 8, the image data of the pre-imaging area 850 can be acquired by imaging the specimen eleven times while shifting the slide 18 in the x direction. The image data acquired by one imaging execution is hereafter called “tile image data”.

According to this embodiment, the light receiving surfaces of the respective imaging elements 1151 to 1154 are disposed such that the focal positions in the z direction are different from one another in the first disposing step, as shown in FIG. 7A. Then imaging by the imaging elements 1151 to 1154 is executed repeatedly while continuously moving the imaging stage 1140 or moving the imaging stage 1140 in steps in the x direction. Thereby four types of image data focused at different depths can be acquired simultaneously for a same area on the xy plane of the slide 18.

In the pre-imaging step, the entire area of the slide 18 in the moving direction (x direction) may be set to the pre-imaging area, but as illustrated in FIG. 8, the area where the specimen does not exist in the xy plane may by excluded from the pre-imaging area, or the tile image data thereof may be discarded after imaging.

In the pre-imaging, scanning is not performed in a direction (y direction) which is perpendicular to the moving direction of the slide 18. In other words, the width of the pre-imaging area in the y direction is the same as the width of one tile image (size of the field of view in the y direction). By limiting the scanning direction to one direction (x direction) like this in the pre-imaging, the time required for the pre-imaging can be shortened. Furthermore, by using image data only on a part of the area (the belt-shaped area in the x direction), instead of on the entire area of the slide or specimen, the speed of the in-focus position determination processing can be increased.

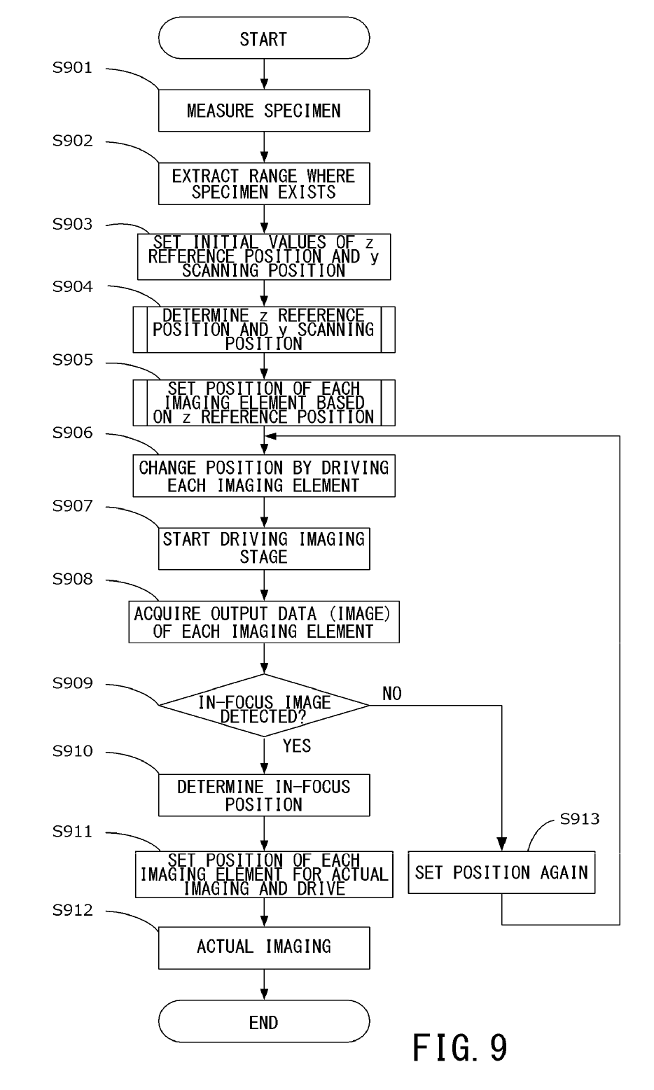

Now the operation of the imaging system 100 will be described with reference to the flow chart in FIG. 9.

First the slide 18 is set on the upper surface of the imaging stage 1140, and is set in the specimen surface profile acquisition unit 120. The slide 18 may be set by the user or may be automatically set by a transport mechanism (e.g. a mechanism that sequentially feeds a slide one at a time onto the imaging stage 1140 from a stocker that stores many slides), which is not illustrated.

The specimen surface profile acquisition unit 120 measures the range where the specimen exists in the xy

plane of the slide, the range where the specimen exists in the z direction, and the surface profile of the specimen, and stores the measurement data (hereafter called “profile data”) in the memory of the system control unit 130 (step S901). The system control unit 130 calculates the range where the specimen exists based on the profile data (step S902).

Based on the calculated range where the specimen exists, the system control unit 130 determines the initial values of the z reference position and the y scanning position (step S903). The z reference position is a position on the z axis (that is, the depth in the specimen) where the focal plane of an imaging element to be the reference (hereafter called “reference imaging element”), out of the plurality of imaging elements, is disposed (this focal plane is also called “reference plane”). The y scanning position is a position on the y axis where the pre-imaging area is disposed.

If the uppermost plane of the plurality of focal planes (four planes in this embodiment) is the reference plane, an average value of the z positions on the surface of the specimen, for example, can be the z reference position. If the center plane of the plurality of focal planes (second or third plane in the case of four planes) is the reference plane, the center value in the range where the specimen exists in the z direction can be the z reference position. The y scanning position is determined based on the range where the specimen exists in the xy plane. It is preferable that the y scanning position is set such that the specimen is included in the pre-imaging area as much as possible. For example, the range where the specimen exists in the x direction (width in the x direction) is evaluated for a plurality of y coordinates, and the y coordinate where the width in the x direction is widest is selected for the y scanning position. In other words, the pre-imaging area is disposed in accordance with the portion of the specimen where the width in the x direction is widest. Alternatively, the center coordinate in the range where the specimen exists in the y direction may be selected for the y scanning direction.

Based on the initial value determined in step S903, the set values of the z reference position and the y scanning position that are actually used for the in-focus position search processing are determined (step S904). If the initial values are directly used for the in-focus position search processing, then the processing in step S904 may be omitted.

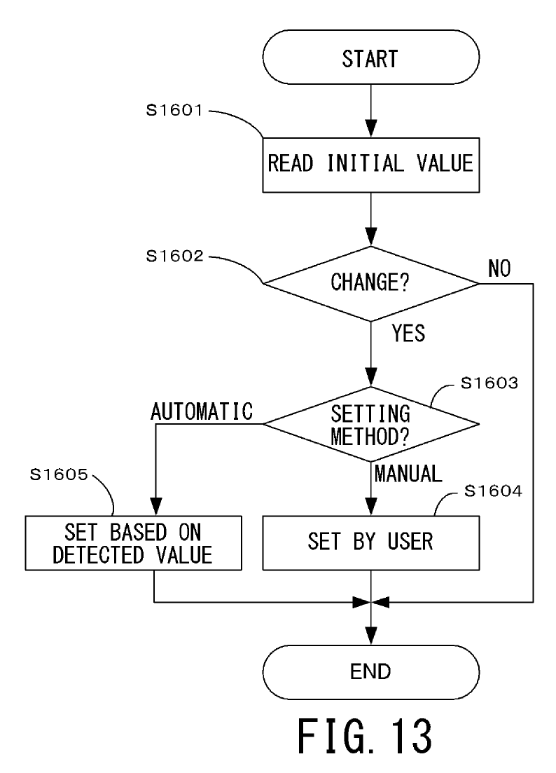

The flow of the set value determination processing in step S904 will be described with reference to the flow chart in FIG. 13.

First the system control unit 130 reads the initial values of the z reference position and the y scanning position from the memory (step S1601). Then the system control unit 130 determines whether it is necessary to change the read initial values (step S1602). Whether the change is required or not may be prompted to the user in step S1602, or may be determined according to the change requirement setting set in advance, or may be determined based on the data measured by the specimen surface profile acquisition unit 120 or reliability of the initial values determined in step S903. If the change is not required (NO in step S1602), the initial values are directly used. If the change is required (YES in step S1602), the system control unit 130 executes either manual setting by the user or automatic setting using the detected values. In the case of the manual setting, the user specifies the desired values of the z reference position and the y scanning position using such an input device as a mouse and keyboard (step S1604). In the case of the automatic setting, the thickness of the specimen is detected from the measurement result by the specimen surface profile acquisition unit 120 (profile data), and the y scanning position is set so that the thinnest portion of the specimen is included in the pre-imaging area (step S1605). The thinnest portion of the specimen is selected for the pre-imaging area because the in-focus range is narrower in the thin portion of the specimen compared with a thick portion of the specimen. The thickness of the specimen can be detected by the quantity of the light that transmits through the specimen. For the z reference position, the initial value may be directly used, or the set value of the z reference position may be determined based on the range where the specimen exists in the xz cross-section at the y scanning position.

Then the system control unit 130 sets each position of the plurality of imaging elements based on the determined set value of the z reference position (step S905).

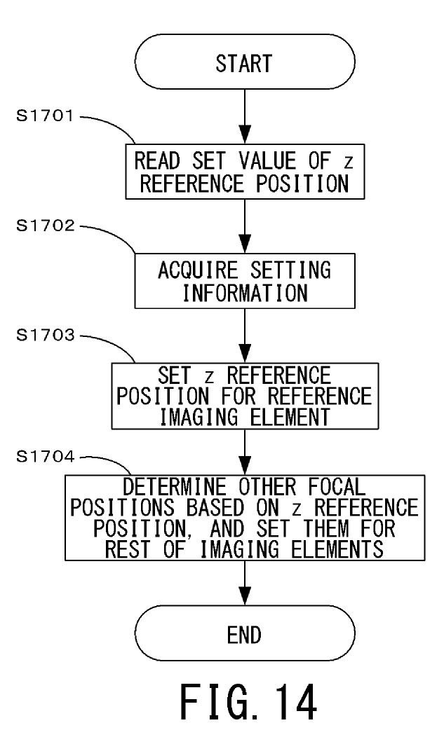

FIG. 14 shows an example of the processing in step S905. The system control unit 130 reads the set value of the z reference position (step S1701). Then the system control unit 130 acquires the setting information (step S1702). The setting information includes the number of imaging elements used for the pre-imaging, disposition intervals of the focal planes, and the range where the specimen exists in the z direction. The information on the number of imaging elements and the disposition intervals of the focal plans have been set in the system in advance. For the range where the specimen exists in the z direction, the range where the specimen exists in the portion of the pre-imaging area may be extracted from the profile data, for example.

The system control unit 130 selects one of the plurality of imaging elements as the reference imaging element, and sets the value of the z reference position, which was read in step S1701, for the reference imaging element (step S1703). Then the system control unit 130 calculates the z positions of the focal planes other than the reference plane based on the information on the z reference position and disposition intervals, and sets the calculated z positions for the imaging elements other than the reference imaging element (step S1704). For example, in the case when the reference plane is the uppermost focal plane and the remaining three focal planes are disposed at equal intervals, if the z reference position is z0 and the interval between the focal planes is p, then the z positions of the four focal planes are z0, z0-p, z0-2×p and z0-3×p in order from the top.

The disposition intervals of the focal planes may be freely set. If the disposition intervals are the same, then processing can be simplified and the range where the specimen exists can be searched without a miss. If the general z position (depth) of the object to be observed can be estimated in this embodiment, then unevenly spaced disposition, such as setting the disposition interval to be narrower near the z position, is preferable in terms of efficiency. As the interval becomes narrower, an improvement in accuracy of detecting the in-focus position can be expected. However, if the interval is too narrow, the number of times of imaging increases and the processing time increases, hence it is desirable to set a lower limit of the interval considering the balance between the detection accuracy and the processing time. The upper limit of the interval can be set based on the relationship with the depth of field of the image forming optical unit 1120 (focal depth on the imaging element side). In concrete terms, the upper limit of the interval is set such that the interval of the focal planes on the object side becomes the depth of field or less. By setting the upper limit of the interval to dispose the imaging elements in this way, at least one of the imaging elements can acquire an in-focus image regardless where the object to be observed exists.

The description with reference to FIG. 9 continues. The system control unit 130 determines the z coordinate to dispose each of the imaging elements 1511 to 1514 based on the z position (z coordinate on the object side) which was set in step S905, and sends a command to each of corresponding motor drivers 1185 to 1188. According to the command, each of imaging element stages 1181 to 1184 drives and disposes each of the imaging elements 1511 to 1514 on a desired z coordinate (step S906: first disposing step). In the same manner, the system control unit 130 drives the imaging stage 1140, and disposes the imaging area of the imaging unit 1130 on the y scanning position.

Then the system control unit 130 drives the imaging stage 1140 in the x direction and loads the slide 18 from the specimen surface profile acquisition unit 120 to the imaging apparatus 110 (step S907). The slide 18 is transported to a position where the imaging start position in the actual imaging (e.g. position at the edge in the x direction (left end in FIG. 8) of the slide or the range where the specimen exists) comes within the field of view of the imaging apparatus 110. In this embodiment, during the load operation, the pre-imaging is executed utilizing the field of view of the imaging apparatus 110 passing through the pre-imaging area. In other words, at the timing when the field of view of the imaging apparatus 110 reaches the pre-imaging area, the system control unit 130 sends an imaging execution instruction to each of the imaging elements 1151 to 1154, and executes the pre-imaging (step S908: first imaging step). For the pre-imaging, the images may be acquired sequentially with moving the slide 18 continuously, or images may be executed for a plurality of times while moving the slide 18 one step at a time.

The image data acquired from each of the imaging elements 1151 to 1154 is sent to the in-focus image identification unit 150 via the system control unit 130, and after necessary processing is performed by the in-focus image identification unit 150, each image is displayed on the monitor 160. The in-focus image identification unit 150 determines whether an in-focus image exists or not by evaluating the contrast or the like of these images (step S909: in-focus position determination step). If an in-focus image exists, the system control unit 130 acquires the position coordinates of the imaging element that acquired this image, and sets the coordinates as an optimum position reference point (step S910). The in-focus image detection result and the information on the optimum position reference point are also displayed on the monitor 160.

The images acquired by the pre-imaging and the in-focus image detection result are displayed on the monitor 160 because the user is able to confirm the processing result. If the processing result is inappropriate, the user may manually selected an in-focus image or set the optimum position reference point. If the confirmation and resetting by the user are unnecessary, this monitor display may be omitted.

If the in-focus image cannot be found in step S909, the system control unit 130 resets the positions of the imaging elements 1151 to 1154 (steps S913, S906). For example, the position of each of the imaging elements 1151 to 1154 is determined so that all the focal planes are repositioned in an area other than the searched range, out of the range where the specimen exists in the z direction, while maintaining the intervals between the focal planes. The focal planes may be moved in the z direction not by moving the imaging elements but by moving the imaging stage 1140 in the z direction. After repositioning the focal planes, the pre-imaging is executed again (steps S907, S908). The same operation is repeated until an in-focus image is found. If the specimen is too thick and the range where the specimen exists in the z direction cannot be scanned by one pre-imaging execution, pre-imaging may need to be executed a plurality of times, with changing the z positions of the focal planes like this.

If the pre-imaging of the entire range where the specimen exists completes without detecting any in-focus image, the pre-imaging may be repeated until the in-focus image is detected, while changing the intervals and disposition of the focal planes and the search position of the specimen. The pre-imaging may be repeated while changing the in-focus determination criteria of a contrast value, edge detection or the like. If priority is assigned to high-speed processing (decreasing the pre-processing time), an in-focus position (optimum position reference point) may always be determined in the images acquired by one pre-imaging execution, without performing the redisposing processing in step S913.

If the optimum position reference point is acquired, the system control unit 130 determines an optimum position of each of the imaging elements 1151 to 1154 based on the optimum position reference point and the profile data, and disposes all the imaging elements 1151 to 1154 again (step S911: second disposing step). Then the system control unit 130 sends the imaging execution instruction to each of the imaging elements 1151 to 1154, and executes the actual imaging (step S912: second imaging step).

According to this embodiment, even if the positioning accuracy of the imaging stage is not very high, the imaging elements can be disposed in optimum positions based on at least one in-focus image, therefore a good general image of the specimen without much blur can be acquired. Further, the imaging system used for detecting the in-focus position and the imaging system used for the actual imaging of the specimen are the same, hence additional equipment for detecting the in-focus position is unnecessary, and the system configuration can be simplified, downsized, and cost can be reduced. By executing the pre-imaging while moving the object 12, the image data used for determining the in-focus position can be efficiently acquired, and as a result, the time until starting the actual processing (time for pre-processing) can be decreased. Moreover, the pre-imaging is executed utilizing the load operation and the load time when the slide is loaded to the imaging position, hence the time for pre-processing can be further decreased.

### Embodiment 2

In Embodiment 1, the tile image data on different depths (z positions) are simultaneously acquired for a single imaging area (xy position) using a plurality of imaging elements (four imaging elements in the illustration). In Embodiment 2, however, tile image data on different depths are simultaneously acquired for each one of a plurality of imaging areas respectively.

An advantage of Embodiment 2 over Embodiment 1 is that the search range in the xy plane becomes wider, although the search range in the z direction (the number of layers of the tile image data in the z direction) becomes smaller. For example, when the specimen spreads throughout the slide, the in-focus position can be detected more efficiently and quickly if the xy plane is widely searched, rather than searching the range with priority where the specimen exist in the z direction.

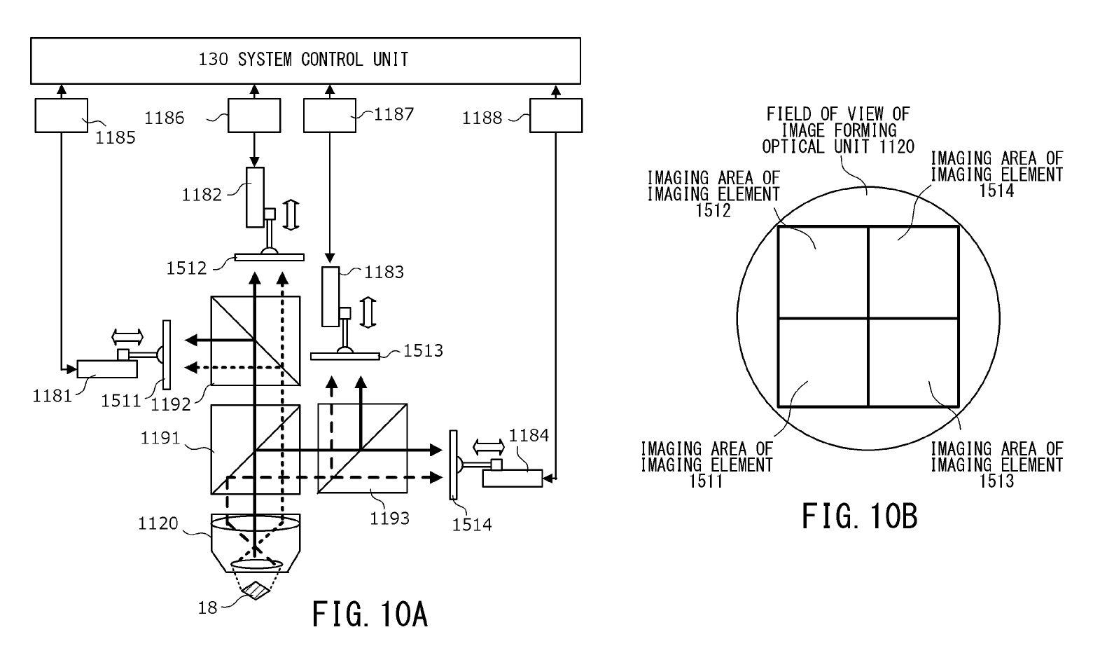

FIG. 10A and FIG. 10B show the configuration of an imaging unit 1130 according to Embodiment 2 of the present invention. In Embodiment 2, an image forming optical unit 1120 having a wider field of view than Embodiment 1 is used, and the optical system and the imaging elements are disposed such that the imaging areas of the four imaging elements 1511 to 1514 are arranged next to one another two rows×two columns within the field of view. By this configuration, image data on a plurality of imaging areas can be simultaneously acquired. Further, image data on the different depths of the specimen can also be acquired by changing the z position of the imaging element.

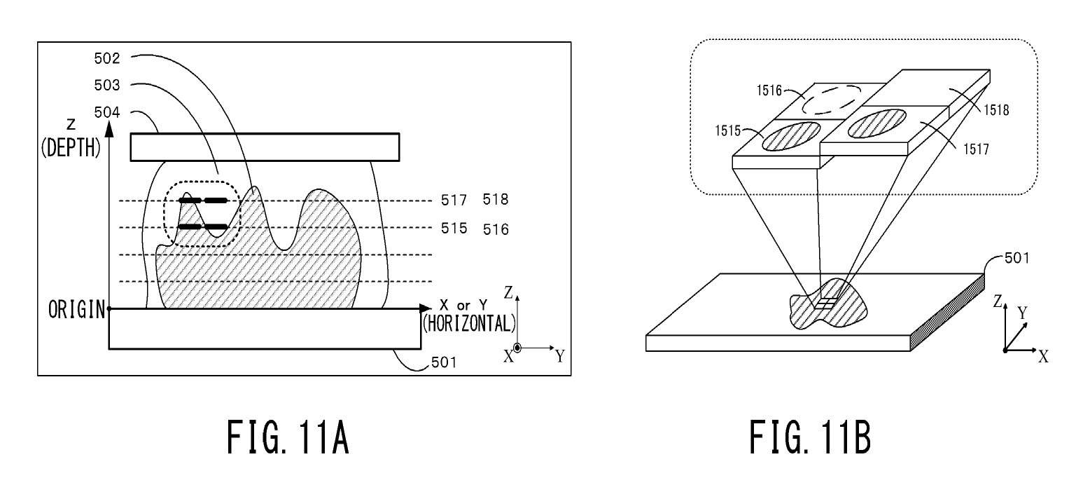

FIG. 11A is a cross-sectional view depicting the disposition of the focal positions of the imaging elements 1511 to 1514 in the in-focus position search processing according to Embodiment 2. 515 to 518 indicate the focal positions (focal planes) in the z direction corresponding to the imaging elements 1511 to 1514 respectively. In other words, in FIG. 11A, the focal positions of the imaging elements 1511 and 1512 are set to a same depth, and the focal positions of the imaging elements 1513 and 1514 are set to a same depth. FIG. 11B is a schematic diagram depicting images 1515 to 1518 that are formed on the light receiving surfaces of the imaging elements 1151 to 1154 respectively in the disposition in FIG. 11A. In the imaging elements 1151 and 1153, of which focal positions 515 and 517 are located in the specimen 502, clear images 1515 and 1517 are acquired. However in the imaging elements 1152 and 1154, of which focal positions 516 and 518 are outside the specimen 502, blurred images 1516 and 1518 are acquired.

In the example of FIG. 11A, the focal positions of the imaging elements 1511 and 1512 match, and the focal positions of the imaging elements 1513 and 1514 match, so that the in-focus position is simultaneously searched for two types of depths, but the focal position may be different for all the imaging elements.

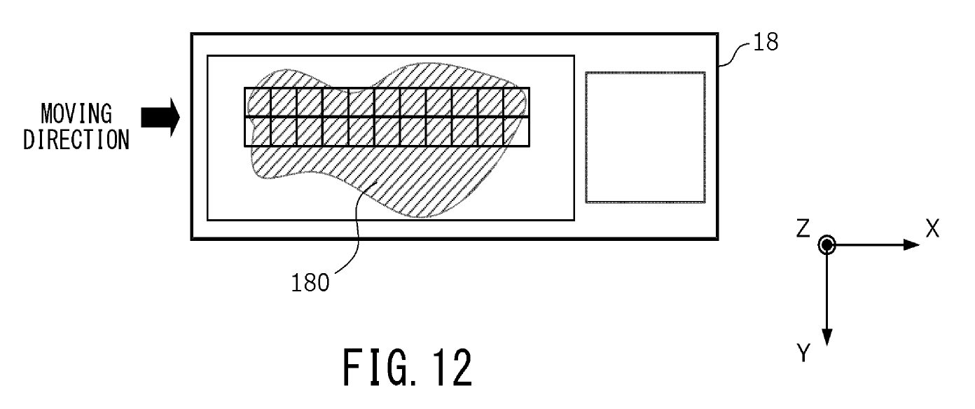

FIG. 12 is a schematic diagram when the pre-imaging area in the pre-imaging step of Embodiment 2 is viewed in the z direction. Since two rows of tile image data can be acquired simultaneously, the searching range in the y direction is expanded to double that of Embodiment 1 (FIG. 8).

The operation of the imaging system 100 in Embodiment 2 is the same as those described with reference to FIG. 9, FIG. 13 and FIG. 14. Only step S1704 in FIG. 14, processing to determine the z positions of the imaging elements, other than the reference imaging element, is slightly different. In other words, for an imaging element of which position in the x direction is the same as the reference imaging element (e.g. imaging element 1511), that is, the imaging element 1512 in this example, the system control unit 130 sets the z position that is the same as the reference imaging element. For an imaging element of which position in the x direction is different from the reference imaging element, that is, the imaging elements 1513 and 1514 in this example, the system control unit 130 sets a z position at a depth that is different from the reference imaging element. In this embodiment, the imaging elements are disposed in 2 rows×2 columns, but three or more imaging elements may be disposed in the x direction and the y direction respectively. In this case, it is preferable that the z positions of the imaging elements disposed in the x direction are set to be different from one another. The disposition interval of the z positions can be freely set, just like Embodiment 1.

According to the configuration of this embodiment described above, the tile image data having different depths (z positions) can be simultaneously acquired from a plurality of imaging areas (xy positions) using a plurality of imaging elements (four elements in the illustration), and a wide range in the xy plane can be searched. Therefore when the specimen spreads throughout the slide, for example, the in-focus position can be detected quickly and efficiently.

### OTHER EMBODIMENTS

Embodiment 1 and Embodiment 2 described above are examples of the present invention, and are not intended to limit the scope of the invention to the configurations of these embodiments. Appropriate modifications of the above mentioned system configurations are also included in the scope of the present invention.

For example, in the embodiments, the positions and intervals of the imaging elements are determined for each specimen in the first disposing step, but the positions and intervals of the imaging elements may be determined in advance. In concrete terms, the set values of the positions and intervals of the imaging elements are preset respectively in a memory of the imaging apparatus or the system control unit, and the disposition of the imaging elements is controlled in the first disposing step according to these set values. An advantage of this method is that control is simple, and processing can be faster.

The above mentioned image processing apparatus may be installed by software (programs) or by hardware. For example, computer programs may be stored in a memory of a computer (e.g. microcomputer, CPU, MPU, FPGA) built into the image processing apparatus, so that the computer executes the computer programs and implements each processing. It is also preferable to install a dedicated processor, such as an ASIC, that implements all or part of the processing of the present invention using logic circuits. The present invention can also be applied to a server in a cloud environment.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-116638, filed on Jun. 5, 2014, which is hereby incorporated by reference herein in its entirety.

What is claimed is:

1. A control method for an imaging apparatus that has an image forming optical system, a plurality of imaging elements and a movable stage for holding an object, the method comprising:
a first disposing step of disposing the plurality of imaging elements in positions which are different in an optical axis direction;
a first imaging step of imaging the object using the plurality of imaging elements disposed in the first disposing step, while moving the object in a direction perpendicular to the optical axis using the movable stage, so as to acquire a plurality of image data of which focal positions with respect to the object in the optical axis direction are different;
an in-focus position determination step of determining an in-focus position with respect to the object, based on the plurality of image data acquired in the first imaging step;
a second disposing step of changing disposition of the plurality of imaging elements, based on the in-focus position determined in the in-focus position determination step; and
a second imaging step of imaging the object using the plurality of imaging elements disposed in the second disposing step.

2. The control method for an imaging apparatus according to claim 1, wherein
the movable stage also serves as means for loading an object from another apparatus, and
the first imaging step is executed when the movable stage is moving for loading the object.

3. The control method for an imaging apparatus according to claim 1, wherein
imaging is performed while moving the object in one direction in the first imaging step.

4. The control method for an imaging apparatus according to claim 1, wherein
image data only on a part of the area of the object is acquired in the first imaging step.

5. The control method for an imaging apparatus according to claim 4, wherein
the part of the area is a belt-shaped area along the moving direction of the object.

6. The control method for an imaging apparatus according to claim 4, wherein
the object is a slide having a specimen, and
the position of the part of the area is set in the first imaging step, based on a range where the specimen exists on the slide.

7. The control method for an imaging apparatus according to claim 4, wherein
the object is a slide having a specimen, and
the position of the part of the area is set in the first imaging step, so as to include a thinnest portion of the specimen.

8. The control method for an imaging apparatus according to claim 1, wherein
disposition of the plurality of imaging elements is set in the first disposing step, so that the focal positions with respect to the object have equal intervals.

9. The control method for an imaging apparatus according to claim 1, wherein
disposition of the plurality of imaging elements is set in the first disposing step, so that the intervals of the focal positions with respect to the object are not more than the depth of field of the image forming optical system.

10. The control method for an imaging apparatus according to claim 1, wherein
the object is a slide having a specimen, and
disposition of the plurality of imaging elements is set in the first disposing step so that the focal positions corresponding to the imaging elements are included in a range where the specimen exists in the optical axis direction.

11. The control method for an imaging apparatus according to claim 1, wherein
in the in-focus position determination step, an imaging element which has acquired an in-focus image is specified by comparing image data acquired from the respective imaging elements in the first imaging step, and the in-focus position which is set in the specified imaging element is selected as the in-focus position.

12. An imaging system comprising:
an image forming optical system;
a plurality of imaging elements;
a movable stage for holding an object; and
a control processing unit, wherein
the control processing unit executes a control that includes:
a first disposing step of disposing the plurality of imaging elements in positions which are different in an optical axis direction;
a first imaging step of imaging the object using the plurality of imaging elements disposed in the first disposing step, while moving the object in a direction perpendicular to the optical axis using the movable stage, so as to acquire a plurality of image data of which focal positions with respect to the object in the optical axis direction are different;
an in-focus position determination step of determining an in-focus position with respect to the object, based on the plurality of image data acquired in the first imaging step;
a second disposing step of changing disposition of the plurality of imaging elements, based on the in-focus position determined in the in-focus position determination step; and
a second imaging step of imaging the object using the plurality of imaging elements disposed in the second disposing step.

13. A non-transitory computer readable storage medium that stores a program for executing each step of the control method for an imaging apparatus according to claim 1, by a control processing unit of the imaging apparatus.
